(19) United States
(12) Patent Application Publication
(10) Pub. No.: US 2007/0107834 A1
(43) Pub. Date: May 17, 2007

(54) METHOD OF MAKING A POLARIZING SHEET

(76) Inventor: Cheng-Hsin Tsai, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 11/164,826

(22) Filed: Dec. 7, 2005

(30) Foreign Application Priority Data
Nov. 15, 2005 (TW) 094140099

(51) Int. Cl. B32B 37/00; B32B 37/20; B32B 38/00; B32B 38/14

(52) U.S. Cl. 156/229; 156/324; 156/314; 156/310

(57) ABSTRACT

This invention relates to a method of making a polarizing sheet or film. The invention starts with swelling an un-stretched PVA film in pure water. The swelled PVA film is dipped into an iodine-containing solution to adsorb iodine. The dyed PVA film is then dipped into a dicarboxylic acid-containing solution while uniaxially stretching the dyed PVA film. The dicarboxylic acid-containing solution further contains boric acid. The stretched PVA film is then laminated with etched TAC films. Just before the lamination of the stretched PVA film and the TAC films, a catalytic aqueous solution containing a strong protonic acid and a Lewis acid such as ZnCl₂ is applied to the stretched PVA film.

### BACKGROUND OF THE INVENTION

1. Field of the Invention

The present invention relates generally to the manufacture of a polarizing sheet and, more particularly, to a method for manufacturing a LCD polarizing sheet having improved resistance to heat and moisture.

2. Description of the Prior Art

Films based on polyvinyl alcohol (PVA) containing iodine or dichroic dyestuffs as polarizing agents are known in the art. Polarizers or polarizing sheets based on PVA dyed with iodine have high polarization characteristics and are widely used in production of liquid-crystal display devices for cell phones, watches, calculators, personal computers, monitors, electronic clocks, word-processors, automobiles, liquid crystal televisions, etc. Besides, more and more LCD devices are now used in relatively severer environments such as, for example, outdoors commercial displays, in-car GPS screens, navigation systems of vehicles, or satellites. The market demand for polarizing sheets with high polarization performance has increased along with the use of such liquid-crystal display devices.

FIG. 1 is a schematic, cross-sectional diagram demonstrating a polarizing sheet 10 according to the prior art. Typically, the polarizing sheet 10 includes an adhesive release film 12, a pressure-sensitive adhesive film 14, a polyvinyl alcohol (PVA) film 18 sandwiched between triacetyl cellulose (TAC) films 16 and 20, and a protective film 22 laminated on the TAC film 20. In other cases, an anti-glare coating, an anti-reflection coating, or an hard-coating may be employed on the TAC film 20. The iodine-type polarizing sheet is more prevalent in the industry than other types because of its high optical performance and because it is cheaper.

Generally, an iodine-type polarizing sheet is produced by lamination of TAC films 16 and 20 on both sides of the PVA film 18. Prior to the lamination, the PVA film 18 undergoes pre-treatment such as swelling, dyeing, and re-stretching. The pre-treated PVA film 18 is laminated with the TAC films 16 and 20, which are also pre-treated with alkaline solution such as sodium hydroxide or potassium hydroxide, by applying aqueous hydrogel containing dissolved PVA powders.

However, the preparation of the aforesaid aqueous hydrogel containing dissolved PVA powders is troublesome and tedious. To dissolve PVA powders, a great deal of time (at least 3-4 hours) and vigorous stir are required. While stirring, the prepared aqueous solution is heated to 80-90° C. Besides, the PVA-containing aqueous hydrogel in prior arts has to be used in one or two days because its stability is not good and aggregation may occur. It is desired to reduce the time required to prepare the aforesaid PVA-containing aqueous hydrogel and to increase its stability.

Another drawback of the iodine-type polarizing sheet in prior arts is that its resistance to heat and moisture is not satisfactory. In some severe environments, the adsorbed molecular iodine decays due to its volatile nature, thus adversely affecting its optical performance. From this aspect, it is desired to improve both the optical performance and durability of the polarizing sheet such that the polarizing sheet can withstand severe environments.

### SUMMARY OF THE INVENTION

It is one object of the present invention to provide a method for manufacturing a LCD polarizing sheet having improved resistance to heat and moisture.

According to the claimed invention, this invention provides a method of making a polarizing sheet. The invention starts with swelling an un-stretched PVA film in pure water. The swelled PVA film is dipped into an iodine-containing solution to adsorb iodine. The dyed PVA film is then dipped into a dicarboxylic acid-containing solution while uniaxially stretching the dyed PVA film. The dicarboxylic acid-containing solution further contains boric acid. The stretched PVA film is then laminated with etched TAC films. Just before the lamination of the stretched PVA film and the TAC films, a catalytic aqueous solution containing a strong protonic acid and a Lewis acid such as ZnCl₂ is applied to the stretched PVA film.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic, cross-sectional diagram demonstrating a polarizing sheet according to the prior art;

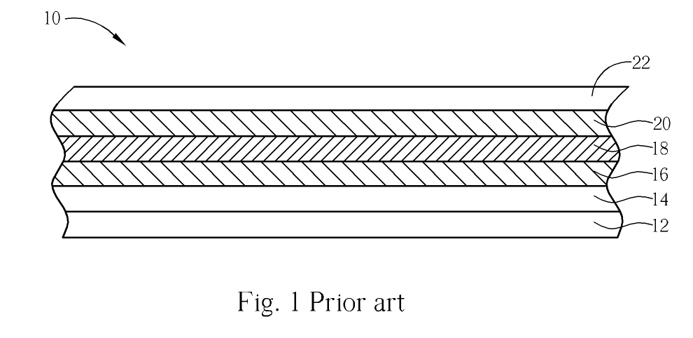

FIG. 2 is a schematic diagram showing the process of manufacturing a polarizing sheet according to one preferred embodiment of this invention;

FIG. 3 demonstrates the structural formula of adipic acid;

FIG. 4 is a schematic diagram demonstrating the surface of the PVA film after stretching; and

FIG. 5 illustrates the results of resistance test.

### DETAILED DESCRIPTION

As previously mentioned, prior to the lamination of the prior art polarizing sheet, the TAC films are pre-treated with alkaline solution such as sodium hydroxide or potassium hydroxide to render the surface of the TAC films hydrophilic. The pre-treated TAC films are then laminated on both sides of the PVA film by applying PVA-containing aqueous hydrogel.

However, the preparation of the PVA-containing aqueous hydrogel is tedious. Further, there is a strong need to improve the stability and adhesive ability of the prior art PVA-containing aqueous hydrogel.

This invention provides a method of making polarizing sheets without using the aforesaid PVA-containing aqueous hydrogel by modifying the stretching process. A composition of PVA-free aqueous solution that is specifically formulated to fit the modified process is employed to replace the PVA-containing aqueous hydrogel in prior arts. The advantages of this invention at least comprise much simplified manufacturing process and better productivity and yield.

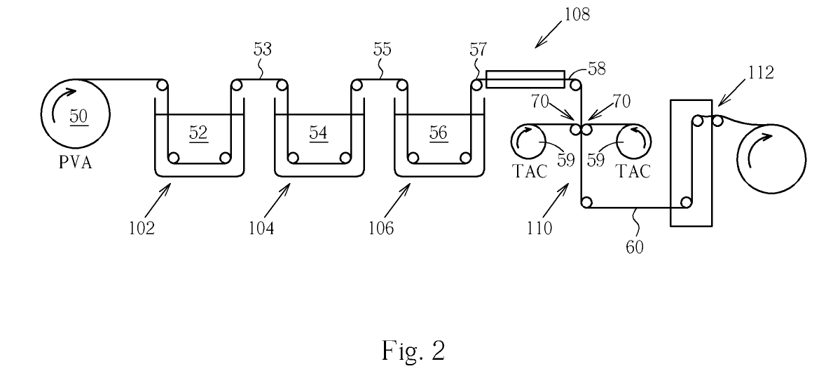

Please refer to FIG. 2. FIG. 2 is a schematic diagram showing the process of manufacturing a polarizing sheet according to one preferred embodiment of this invention. As shown in FIG. 2, the process generally includes the following steps:

Step 102: swelling;

Step 104: dyeing;

Step 106: stretching;

Step 108: drying;

Step 110: lamination; and

Step 112: drying.

It is one feature of the present invention that in the process of manufacturing a polarizing sheet according to one preferred embodiment of this invention, no PVA-containing hydrogel as the prior art is employed.

Starting with Step 102, an un-stretched PVA film 50 is dipped in pure water 52 and swells. In Step 104, the swelled PVA film 53 is then dipped into dye solution 54 containing iodine to adsorb iodine. The dye solution 54 basically contains molecular iodine and potassium iodide with an iodine concentration of about 0.01 wt. % to 0.5 wt. %.

In Step 106, the dyed PVA film 55 is stretched. Step 106 is a uniaxially stretching process. The dyed PVA film 55 is dipped into cross-linking solution 56 containing boric acid and potassium iodide with a boric acid concentration of about 1 wt. % to 10 wt. %.

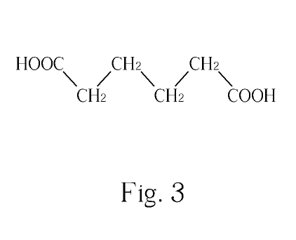

According to the preferred embodiment of this invention, the stretched PVA film 57 has a total stretching ratio of about 4 to 7. It is one feature of this invention that the cross-linking solution 56 further comprises dicarboxylic acid such as adipic acid (HOOCC₄H₈COOH), glutaric acid or succinic acid, preferably adipic acid. The structural formula of adipic acid is demonstrated in FIG. 3.

It is believed that the dicarboxylic acid added in cross-linking solution 56 reacts with surface hydroxyl groups during stretching in Step 106. According to the preferred embodiment of this invention, the concentration of the dicarboxylic acid ranges between 1 wt. % and 5 wt. %.

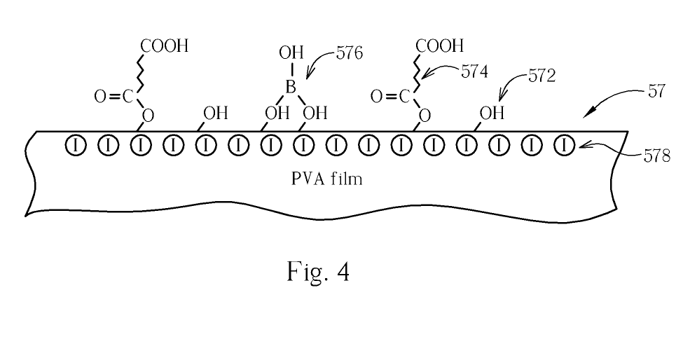

Please refer to FIG. 4. FIG. 4 is a schematic diagram demonstrating the surface of the PVA film 57 after treated with Step 106. By way of example, in Step 106, adipic acid is added as a component of the cross-linking solution 56. As can be seen in FIG. 3, each adipic acid has two carboxyl groups at its two ends. One of the carboxyl groups of adipic acid reacts with hydroxyl group 572 on the surface of the PVA film 57, thus producing chemical bonding structure 574. This reaction is also referred to as esterification.

Moreover, the boric acid in the cross-linking solution 56 also reacts with the surface of the PVA film 57 to form hydrophobic structure 576, which prevents the absorbed iodine 578 from diffusing out of the PVA film 57.

Subsequently, as shown in FIG. 2, after stretching, Step 108 is carried out to dry the PVA film 57. The dried PVA film 58 is then subjected to aqueous catalytic solution 70.

In Step 110, triacetyl cellulose (TAC) films 59 are laminated on both sides of the PVA film 58 to form TAC-PVA-TAC film stack 60. The TAC films 59 are pre-treated with alkaline solution. The other carboxyl group of the adipic acid on the PVA film 58 reacts with hydroxyl group of the TAC films 59 (esterification catalyzed by aqueous catalytic solution 70) to form chemical bonding between the PVA film 58 and the TAC films 59, such that the PVA film 58 and TAC films 59 are tightly bonded together. The aqueous catalytic solution 70 may be dropped on the PVA film 58 in Step 110, or between Step 108 and Step 110.

According to the preferred embodiment of this invention, the aqueous catalytic solution 70 comprises metal salts and strong protonic acid such as hydrochloric acid, sulfuric acid or nitric acid. The aforesaid metal salts may comprise inorganic salts containing zinc or magnesium, for example, ZnCl₂, MgCl₂, ZnBr₂ or ZnI₂, preferably ZnCl₂. The concentration of the metal salt ranges between 1 wt. % and 5 wt. %. The concentration of the strong protonic acid ranges between 0.1 M and 0.5 M.

Zinc chloride is a known Lewis acid and is sometimes used as a catalyst in other fields. Further, to speed up the following dry process, it is recommended to add volatile and hydrophilic solvent such as methanol into the aqueous catalytic solution 70.

Finally, in Step 112, the TAC-PVA-TAC film stack 60 is then subjected to a 50-80° C. drying process. Since the methanol is added, the time required for the drying process can be reduced. Further, to enhance the function of the polarizing sheet, the TAC films may coated with, for example, liquid crystal layer, protective layer, anti-glare layer, anti-reflection layer or anti-scratch or anti-smear layers prior to the alkaline treatment.

To more explain the features and advantages of this invention, one preferred example (best mode) and four comparison examples are demonstrated. In the preferred example, adipic acid is added into the cross-linking solution (Step 106: stretching) and the aqueous catalytic solution contains no PVA (Step 110: PVA-TAC lamination). In the first comparison example, the adhesive glue used during PVA-TAC lamination (Step 110) contains no PVA. The other three comparison examples use PVA-containing aqueous hydrogel glue. The four comparison examples use cross-linking solution that contains no adipic acid in Step 106.

### PREFERRED EXAMPLE (BEST MODE)

Weighted adipic acid was dissolved in the aqueous cross-linking solution. The dry PVA film was prepared and treated according to the processing steps mentioned above and in FIG. 2. Lamination of the polarizing PVA film and TAC films was performed using the catalytic solution which was prepared in advance by mixing methanol (MeOH), zinc chloride and hydrochloric acid. The combinatory effect of added adipic acid in the cross-linking solution and the content of the catalytic solution provides the required adhesive property. The TAC-PVA-TAC film stack was subjected to heat and moisture test performed in a 70° C. hot water bath.

### FIRST COMPARISON EXAMPLE

Weighted adipic acid was first dissolved in hot water and the rest three elements including glyoxal, zinc chloride and hydrochloric acid were added. Clear and colorless glue was obtained after careful stirring, yielding the PVA-free chemical glue. The time required for preparation is less than ten minutes. The PVA-free chemical glue was used in the manufacture of polarizers according to typical procedures and likewise the formed TAC-PVA-TAC film stack is subjected to heat and moisture test performed in a 70° C. hot water bath.

### SECOND COMPARISON EXAMPLE

Weighted PVA powders were dissolved in hot water, heated and stirred vigorously in order to prevent aggregation. The solution was cooled to room temperature under stirring conditions. Vaporized water is refilled and the solution was filtrated to remove aggregates, yielding a hydrogel with 5% PVA content. The time required for preparation was few hours. The PVA-type hydrogel was used in the manufacture of polarizers according to typical procedures and the formed TAC-PVA-TAC film stack is subjected to heat and moisture test performed in a 50° C. hot water bath.

### THIRD COMPARISON EXAMPLE

Weighted PVA powders were dissolved in hot water, heated and stirred vigorously in order to prevent aggregation. The solution was cooled to room temperature, refilled with water to compensate lost weight during heating, and added with weighted additives including boric acid and zinc chloride which were added under stirring conditions. The mixture was filtrated to remove aggregates, yielding a hydrogel with 5% PVA content. The time required for preparation was few hours. The PVA-type hydrogel was used in the manufacture of polarizers according to typical procedures and the formed TAC-PVA-TAC film stack is subjected to heat and moisture test performed in a 50° C. hot water bath.

### FOURTH COMPARISON EXAMPLE

Weighted PVA powders were dissolved in hot water, heated and stirred vigorously in order to prevent aggregation. The solution was cooled to room temperature, refilled with water to compensate lost weight during heating, and added with weighted additives including hydrochloric acid, glyoxal and zinc chloride which were added under stirring conditions. The mixture was filtrated to remove aggregates, yielding a hydrogel with 5% PVA content. The time required for preparation was few hours. The PVA-type hydrogel was used in the manufacture of polarizers according to typical procedures and the formed TAC-PVA-TAC film stack is subjected to heat and moisture test performed in a 50° C. hot water bath.

Resistance test:

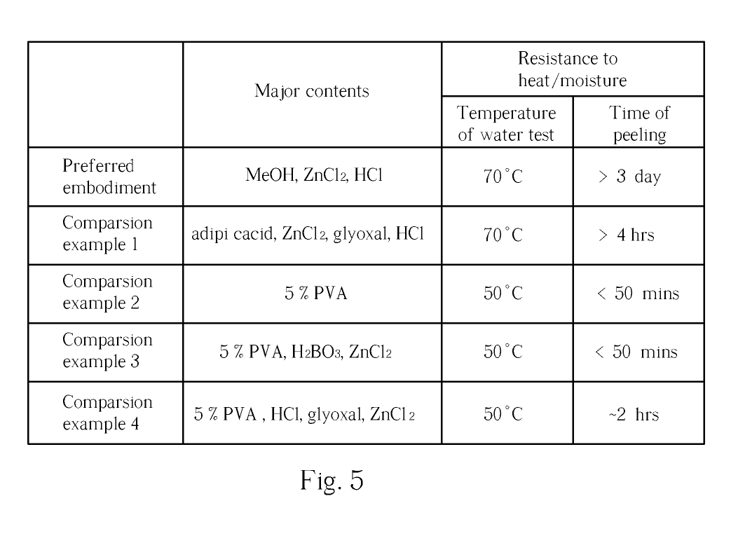

The resistance to heat and moisture of the formed TAC-PVA-TAC film stack is presented in term of time of peeling as can be seen in the fourth column of comparison table in FIG. 5. In order to monitor the resistance to heat and moisture, the produced polarizers or TAC-PVA-TAC film stacks are exposed to severe environmental conditions. The polarizers were immersed into water bath at 70° C. for the preferred example and the first comparison example, while water bath at 50° C. for the third to fourth comparison examples. The resistance to heat and moisture of the TAC-PVA-TAC film stack made according to the preferred example is significantly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of making a polarizing sheet, comprising:
preparing a polyvinyl alcohol (PVA) film;
performing a dying process by dipping the PVA film into dye-containing solution;
uniaxially stretching the PVA film by dipping the PVA film into a cross-linking solution containing dicarboxylic acid and boric acid; and
applying aqueous catalytic solution to the PVA film and laminating the PVA film with alkaline treated triacetyl cellulose (TAC) film, wherein the aqueous catalytic solution contains metal salts and protonic acid.

2. The method according to claim 1 wherein the dye-containing solution contains iodine.

3. The method according to claim 1 wherein the dye-containing solution contains potassium iodide.

4. The method according to claim 1 wherein the cross-linking solution contains potassium iodide.

5. The method according to claim 1 wherein the dicarboxylic acid comprises adipic acid, glutaric acid or succinic acid.

6. The method according to claim 1 wherein the metal salts comprise inorganic metal salts containing zinc or magnesium ions.

7. The method according to claim 1 wherein the protonic acid comprise hydrochloric acid, sulfuric acid and nitric acid.

8. The method according to claim 1 wherein the aqueous catalytic solution further comprises volatile, hydrophilic agent.

9. The method according to claim 8 wherein the volatile, hydrophilic agent comprises methanol.

10. A method of making a polarizing sheet, comprising:
preparing a polyvinyl alcohol (PVA) film;
performing a dying process by dipping the PVA film into dye-containing solution;
uniaxially stretching the PVA film by dipping the PVA film into a cross-linking solution containing dicarboxylic acid and boric acid; and
applying aqueous catalytic solution to the PVA film and laminating the PVA film with alkaline treated triacetyl cellulose (TAC) film, wherein the aqueous catalytic solution contains Lewis acid and at least one strong protonic acid.

11. The method according to claim 10 wherein the dye-containing solution contains iodine.

12. The method according to claim 10 wherein the dye-containing solution contains potassium iodide.

13. The method according to claim 10 wherein the cross-linking solution contains potassium iodide.

14. The method according to claim 10 wherein the dicarboxylic acid is adipic acid.

15. The method according to claim 10 wherein the Lewis acid is zinc chloride.

16. The method according to claim 10 wherein the strong protonic acid is hydrochloric acid.

17. The method according to claim 10 wherein the aqueous catalytic solution further comprises volatile, hydrophilic agent.

18. The method according to claim 17 wherein the volatile, hydrophilic agent comprises methanol.
